(19) United States
(12) Patent Application Publication
(10) Pub. No.: US 2006/0048335 A1
(43) Pub. Date: Mar. 9, 2006

(54) Bore caster

(76) Inventor: Peter C. Michalos, Englewood Cliffs, NJ (US)

Correspondence Address: NOTARO & MICHALOS P.C., 100 DUTCH HILL ROAD, SUITE 110, ORANGEBURG, NY, 10962-2100, US

(21) Appl. No.: 10/933,805

(22) Filed: Sep. 3, 2004

(51) Int. Cl. B60B 33/00

(52) U.S. Cl. 16/43

(57) ABSTRACT

A caster has a cylindrical housing defining a cylindrical bore with a pair of spaced apart cord shaped journals in the bore. The journals have aligned openings and a shaft extends in the openings and across the space between the journals. A roller is mounted for rotation on the shaft and in the space between the journals and a bearing is mounted between the roller and the shaft. The bearing is between the journals for holding the journals apart and it has an axial length that is greater than the axial width of the roller so that the roller rotates freely between the journals.

### FIELD AND BACKGROUND OF THE INVENTION

The present invention relates generally to the field of rollers, conveyors and casters, and in particular, to a new and useful caster that can be mounted in the floor or in any surface containing a bore.

### SUMMARY OF THE INVENTION

It is an object of the present invention to provide a caster comprising means defining a cylindrical bore, a pair of spaced apart cord shaped journals in the bore, the journals having aligned openings therein, a shaft extending in the openings and across the space between the journals, and a roller mounted for rotation on the shaft and in the space between the journals.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is an exploded view of the caster of the present invention;

FIG. 2 is a side view thereof, partly in section;

FIG. 3 is a sectional view thereof taken along the axis of rotation of the roller; and

FIG. 4 is a horizontal sectional view thereof taken through the axis of rotation.

### DESCRIPTION OF THE PREFERRED EMBODIMENTS

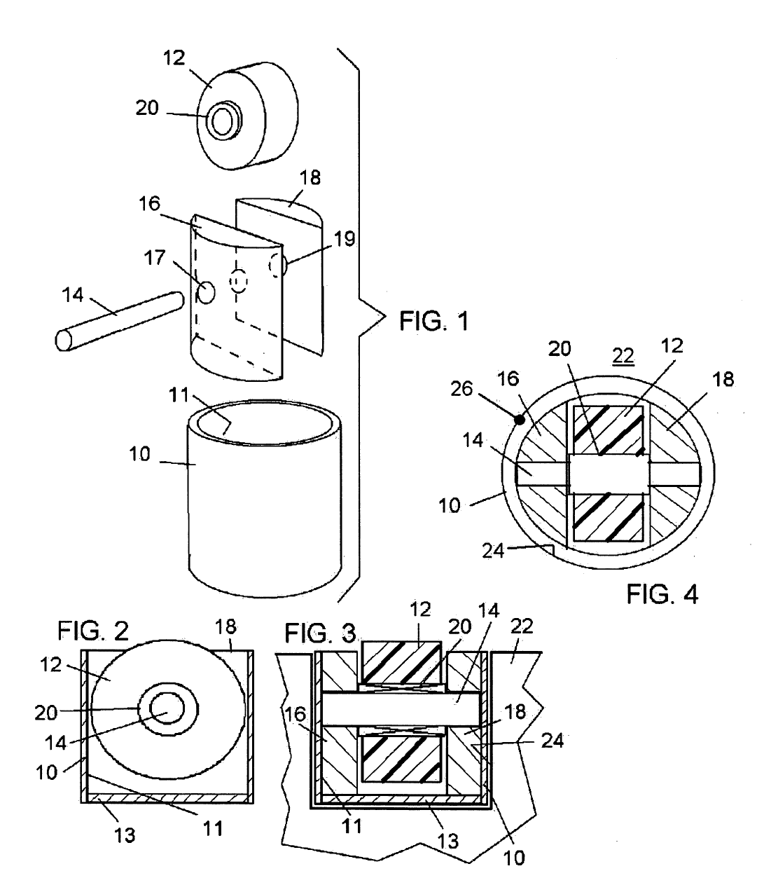

Referring now to the drawings, in which like reference numerals are used to refer to the same or similar elements, FIG. 1 illustrates the caster of the present invention, for mounting in a bore and comprising means, such as a metal cylindrical housing 10, for defining a cylindrical bore 11, and a pair of spaced apart cord shaped journals 16 and 18 in the bore as shown in FIGS. 2 and 3. The journals 16,18 have aligned openings 17 and 19 therein for receiving a shaft 14 which extends across the space between the journals as shown in FIGS. 3 and 4. A roller 12 is mounted for rotation on the shaft 14 and in the space between the journals, or on a ball, roller or other bearing 20, which, in turn is mounted on the shaft 14. Openings 17,19 are positioned so that at least part of the outer circumference of roller 12 extends above the open upper end of housing 10 as shown in FIG. 2, for example, so that the roller can engage items to be rolled over housing 10, to allow then to move easily.

Journals 16, 18 may be made of metal or plastic and shaft 14 may be metal, or if only light loads are to be placed on roller 12, shaft 14 may also be of plastic. Roller 12 is made of rubber or elastomer for light loads, or may be of metal for heavier loads. Housing 10 may be of metal or plastic and may have a bottom wall 13 for closing the bore 11.

The bearing 20 is advantageously slightly longer than the axial width of roller 12 so that the bearing will act as a spacer in the bore 11, to hold journals 16 and 18 apart. This will also leave sufficient clearance for free rotation of roller 12 in the space between the journals. Shaft 14 extending in bearing 20 and is confined between the walls of bore 11 in the openings 17, 19.

Alternatively, the shaft 14 may have a large diameter portion centered between the journals, acting as the bearing and to hold the journals apart, with smaller diameter portions extending into the openings 17, 19.

Thus, the entire subassembly of roller 12, bearing 20, shaft 14 and journals 16,18 can be dropped into bore 11 and retained there by press-fitting or simply by gravity without requiring adhesive, screws or any other fasteners to hold the subassembly together. The caster assembly made up of the subassembly plus the housing 10, can then be dropped or press fit into a blind bore, e.g. the bore 24 in a floor 22 of FIG. 3.

For cleaning, the caster assembly or the subassembly is easily removed, disassembled, cleaned and returned to the bore 11 and the blind bore 24.

For installation, any surface, e.g. a concrete warehouse floor 22 in FIG. 3, may be prepared by drilling a plurality of spaced apart blind bores 24 in the floor. Each blind bore will then receive one of the caster assemblies. If the blind bores 24 are provided in an elongated rectangular matrix, this will create a roller conveyor surface on the floor.

Alternatively, a blind bore can be made in the bottom surface of a piece of furniture or other structure, and the caster assembly inserted from below. In that case some means such as adhesive may be needed to retain the housing 10 in the blind bore, and the journals 16, 18 in the housing.

In another even more simplified embodiment of the invention, the housing 10 is eliminated and the blind bore 24 serves as the retaining bore for the subassembly of roller 12, bearing 20, journals 16,18, and shaft 14.

Roller 12 is show to be cylindrical but it can have a convex outer surface of a concave outer surface. Each journal 16 and 18 has a cylindrical outer surface in contact with the surface of bore 11 (or directly with bore 24 if no housing 10 is provided) and an inner planar surface facing the roller and contacting the bearing 20 which holds the journals firmly against the bore wall.

Bottom wall 13 helps to enclose the housing 10 from below in case the material of the floor 22 is prone to dust and granules as in the case of concrete, to keep the bearing 20 cleaner for free rotation of roller 12.

With only 5 or 6 major parts, the bore caster of the present invention provides a simple but robust mechanism for rolling items over a surface or for rolling a structure with the bore casters of the invention, over a surface.

When multiple caster assemblies are to be used to create one conveyer path, it is advantageous to fix the relative rotational position of the housing 10 in its blind bore 24. One example is illustrated in FIG. 4, where a fixing pin 26 has been inserted into a corresponding fixing hole drilled between the outer surface of housing 10 and the blind bore 24.

While a specific embodiment of the invention has been shown and described in detail to illustrate the application of the principles of the invention, it will be understood that the invention may be embodied otherwise without departing from such principles.

1. A caster comprising:
means for defining a cylindrical bore;
a pair of spaced apart cord shaped journals in the bore, the journals having aligned openings therein and having outer surfaces conforming to an inner surface of the cylindrical bore;
a shaft extending in the openings and across the space between the journals;
a roller mounted for rotation on the shaft and in the space between the journals; and
a bearing mounted between the roller and the shaft.

2. A caster according to claim 1, wherein the means for defining a cylindrical bore comprise a blind bore in a surface.

3. A caster according to claim 1, wherein the means for defining a cylindrical bore comprise a cylindrical housing.

4. A caster according to claim 1, wherein the means for defining a cylindrical bore comprise a cylindrical housing having a closed end and an open end.

5. A caster according to claim 1, wherein the roller is cylindrical.

6. (canceled)

7. A caster according to claim 1, wherein the bearing comprises a large diameter portion of the shaft.

8. A caster according to claim 1, the bearing being between the journals for holding the journals apart in the cylindrical bore, the bearing having an axial length that is greater than the axial width of the roller so that the roller rotates freely between the journals.

9. A caster according to claim 8, wherein the bearing comprises a large diameter portion of the shaft.

10. A caster comprising:
means for defining a cylindrical bore;
a pair of spaced apart cord shaped journals in the bore, the journals having aligned openings therein;
a shaft extending in the openings and across the space between the journals;
a roller mounted for rotation on the shaft and in the space between the journals; and
a bearing mounted between the roller and the shaft, the bearing being between the journals for holding the journals apart, the bearing having an axial length that is greater than the axial width of the roller so that the roller rotates freely between the journals.

11. A caster according to claim 10, wherein the means for defining a cylindrical bore comprise a blind bore in a surface.

12. A caster according to claim 10, wherein the means for defining a cylindrical bore comprise a cylindrical housing.

13. A caster according to claim 10, wherein the means for defining a cylindrical bore comprise a cylindrical housing having a closed end and an open end.

14. A caster according to claim 10, wherein the roller is cylindrical.

15. A caster comprising:
a cylindrical housing defining a cylindrical bore;
a pair of spaced apart cord shaped journals in the bore, the journals having aligned openings therein;
a shaft extending in the openings and across the space between the journals;
a roller mounted for rotation on the shaft and in the space between the journals; and
a bearing mounted between the roller and the shaft, the bearing being between the journals for holding the journals apart, the bearing having an axial length that is greater than the axial width of the roller so that the roller rotates freely between the journals.

16. A caster according to claim 15, wherein the cylindrical housing has a closed end and an open end.

17. A caster according to claim 15, wherein the roller is cylindrical.
